(19) United States
(12) Patent Application Publication
(10) Pub. No.: US 2026/0003661 A1
(43) Pub. Date: Jan. 1, 2026

(54) REMOTE DIRECT MEMORY ACCESS METHOD AND APPARATUS

(71) Applicant: Beijing Volcano Engine Technology Co., Ltd., Beijing (CN)

(72) Inventors: Lidong JIANG, Beijing (CN); Bin NIU, Beijing (CN); Zhaoyang WEI, Beijing (CN); Yuqi CHAI, Beijing (CN); Ying AN, Beijing (CN); Deguo LI, Beijing (CN); Yirui LIU, Beijing (CN)

(21) Appl. No.: 19/172,372

(22) Filed: Apr. 7, 2025

(30) Foreign Application Priority Data
Jun. 28, 2024 (CN) 202410869752.5

(51) Int. Cl. G06F 9/455; H04L 12/46

(52) U.S. Cl. CPC G06F 9/45558; H04L 12/4641; G06F 2009/45583

(57) ABSTRACT

Embodiments of the present application provide a remote direct memory access method and apparatus, and relate to the field of computer technologies. The method includes: receiving a first virtual extensible local area network (VXLAN) message sent by a first virtual machine to a second virtual machine through a VXLAN tunnel, where the first VXLAN message is generated by performing VXLAN encapsulation on a remote direct memory access (RDMA) over Converged Ethernet (RoCE) message; and performing VXLAN decapsulation on the first VXLAN message through a hardware programmable network interface card based on a virtual switch, to obtain a first RoCE message, and performing access control on the first RoCE message through the hardware programmable network interface card, where the hardware programmable network interface card based on the virtual switch is preconfigured based on software of the virtual switch.

### CROSS-REFERENCE TO RELATED APPLICATION(S)

This application claims priority to Chinese Application No. 202410869752.5 filed on Jun. 28, 2024, the disclosure of which is incorporated herein by reference in its entirety.

### FIELD

The present application relates to the field of computer technologies, and in particular, to a remote direct memory access method and apparatus.

### BACKGROUND

Remote direct memory access (RDMA) is a memory access technology, and RoCEv2 (RDMA over Converged Ethernet version 2, a remote direct memory access protocol based on Ethernet) is a second version of ROCE. Data may be directly transmitted from a memory of a computer to another computer by RoCEv2, and the data is quickly moved from a system to a remote system memory without intervention of operating systems of the two parties and without processing by a processor, so as to finally achieve effects of high bandwidth, low latency, and low resource utilization. On the other hand, a virtual private cloud (VPC) may provide network isolation and security, and allows a user to create a private network environment in a public cloud and allows a plurality of virtual machines (VM) to be constructed on a same physical infrastructure, to support a multi-tenant architecture, and allows the user to define and implement a fine-grained security policy.

In the virtual private cloud environment, a virtual switch is configured between virtual machines to transmit messages, and the virtual switch forwards a message by using software. Software forwarding of the virtual switch can satisfy a delay requirement of most applications based on a transmission control protocol (TCP).

### SUMMARY

In view of this, embodiments of the present application provide a remote direct memory access method and apparatus, which are used to reduce a delay of a RoCE message in a virtual private cloud environment.

To achieve the above objective, embodiments of the present application provide the following technical solutions.

According to a first aspect, an embodiment of the present application provides a remote direct memory access method. The method includes:
receiving a first virtual extensible local area network (VXLAN) message sent by a first virtual machine to a second virtual machine through a VXLAN tunnel, and the first VXLAN message is generated by performing VXLAN encapsulation on a remote direct memory access (RDMA) over Converged Ethernet (ROCE) message; and performing VXLAN decapsulation on the first VXLAN message through a hardware programmable network interface card based on a virtual switch, to obtain a first RoCE message, and performing access control on the first RoCE message through the hardware programmable network interface card, where the hardware programmable network interface card based on the virtual switch is preconfigured based on software of the virtual switch to implement software functions of the virtual switch through hardware of the network interface card.

In an optional implementation of this embodiment of the present application, the performing access control on the first RoCE message through the hardware programmable network interface card includes:
obtaining a source network protocol address, a destination network protocol address, and a destination port of the first RoCE message;
obtaining an access control identifier corresponding to the first RoCE message based on the source network protocol address, the destination network protocol address, and the destination port of the first ROCE message;
determining an access control policy group corresponding to the first RoCE message based on the access control identifier corresponding to the first RoCE message and access control identifiers of access control policy groups that are preconfigured in the hardware programmable network interface card; and
determining, based on an access control policy in the access control policy group corresponding to the first RoCE message, whether the first RoCE message is allowed to be forwarded.

In an optional implementation of this embodiment of the present application, the method further includes:
in the case where it is determined that the first RoCE message is allowed to be forwarded, forwarding the first RoCE message to a RoCE network interface card of the second virtual machine through the hardware programmable network interface card; or
in the case where it is determined that the first RoCE message is prohibited from being forwarded, processing the first RoCE message based on first preset software.

In an optional implementation of this embodiment of the present application, the method further includes:
determining, through the hardware programmable network interface card, whether an outer network protocol header of the first RoCE message includes an explicit congestion notification (ECN) mark; and if the outer network protocol header of the first RoCE message includes the ECN mark, adding the ECN mark to an inner network protocol header of the first RoCE message.

In an optional implementation of this embodiment of the present application, the method further includes:
performing, through the hardware programmable network interface card, bandwidth measurement on traffic of a RoCE message sent by the first virtual machine, to obtain a first bandwidth, and determining whether the first bandwidth is greater than a bandwidth threshold; and if the first bandwidth is greater than the bandwidth threshold, adding an ECN mark to an inner network protocol header of the first RoCE message.

In an optional implementation of this embodiment of the present application, the method further includes:
receiving a second RoCE message output by a RoCE network interface card of the second virtual machine; and
performing access control on the second RoCE message through the hardware programmable network interface card, and if it is determined that the second RoCE message is allowed to be forwarded, performing VXLAN encapsulation on the second RoCE message through the hardware programmable network interface card, to obtain a second VXLAN message, and sending the second VXLAN message through the VXLAN tunnel.

In an optional implementation of this embodiment of the present application, the performing access control on the second RoCE message through the hardware programmable network interface card includes:
obtaining a source network protocol address, a destination network protocol address, and a destination port of the second RoCE message;
obtaining an access control identifier corresponding to the second RoCE message based on the source network protocol address, the destination network protocol address, and the destination port of the second ROCE message;
determining an access control policy group corresponding to the second RoCE message based on the access control identifier corresponding to the second RoCE message and access control identifiers of access control policy groups that are preconfigured in the hardware programmable network interface card; and
determining, based on an access control policy in the access control policy group corresponding to the second RoCE message, whether the second RoCE message is allowed to be forwarded.

In an optional implementation of this embodiment of the present application, the method further includes:
in the case where it is determined that the second RoCE message is prohibited from being forwarded, processing the second RoCE message based on second preset software.

In an optional implementation of this embodiment of the present application, the method further includes:
determining, through the hardware programmable network interface card, whether the second ROCE message is a congestion notification packet (CNP) message; if the second RoCE message is the CNP message, setting a value of a differentiated services code point (DSCP) in an outer network protocol header of the second RoCE message to a first preset value; or if the second RoCE message is not the CNP message, setting a value of a DSCP in the outer network protocol header of the second RoCE message to a second preset value.

In an optional implementation of this embodiment of the present application, the sending the second VXLAN message through the VXLAN tunnel includes:
writing the second VXLAN message into a message queue, and sequentially sending VXLAN messages in the message queue at a rate less than or equal to a second bandwidth.

According to a second aspect, an embodiment of the present application provides a remote direct memory access apparatus. The apparatus includes:
a receiving unit, configured to receive a first virtual extensible local area network (VXLAN) message sent by a first virtual machine to a second virtual machine through a VXLAN tunnel, where the first VXLAN message is generated by performing VXLAN encapsulation on a remote direct memory access (RDMA) over Converged Ethernet (RoCE) message; and
a processing unit, configured to perform VXLAN decapsulation on the first VXLAN message through a hardware programmable network interface card based on a virtual switch, to obtain a first RoCE message, and perform access control on the first RoCE message through the hardware programmable network interface card, where the hardware programmable network interface card based on the virtual switch is preconfigured based on software of the virtual switch, so that software functions of the virtual switch are implemented through hardware of the network interface card.

In an optional implementation of this embodiment of the present application, the processing unit is further configured to obtain, through the hardware programmable network interface card, the source network protocol address, the destination network protocol address, and the destination port of the first RoCE message; obtain the access control identifier corresponding to the first RoCE message based on the source network protocol address, the destination network protocol address, and the destination port of the first RoCE message; determine the access control policy group corresponding to the first RoCE message based on the access control identifier corresponding to the first RoCE message and the access control identifiers of the access control policy groups that are preconfigured in the hardware programmable network interface card; and determine, based on the access control policy in the access control policy group corresponding to the first RoCE message, whether the first RoCE message is allowed to be forwarded.

In an optional implementation of this embodiment of the present application, the processing unit is further configured to: in the case where it is determined that the first RoCE message is allowed to be forwarded, forward the first RoCE message to the ROCE network interface card of the second virtual machine through the hardware programmable network interface card; or in the case where it is determined that the first RoCE message is prohibited from being forwarded, process the first RoCE message based on the first preset software.

In an optional implementation of this embodiment of the present application, the processing unit is further configured to determine, through the hardware programmable network interface card, whether the outer network protocol header of the first RoCE message includes the explicit congestion notification (ECN) mark; and if the outer network protocol header of the first RoCE message includes the ECN mark, add the ECN mark to the inner network protocol header of the first RoCE message.

In an optional implementation of this embodiment of the present application, the processing unit is further configured to perform, through the hardware programmable network interface card, bandwidth measurement on traffic of a RoCE message sent by the first virtual machine, to obtain a first bandwidth, and determine whether the first bandwidth is greater than a bandwidth threshold; and if the first bandwidth is greater than the bandwidth threshold, add an ECN mark to an inner network protocol header of the first RoCE message.

In an optional implementation of this embodiment of the present application, the receiving unit is further configured to receive a second RoCE message output by a RoCE network interface card of the second virtual machine.

The processing unit is further configured to perform access control on the second RoCE message through the hardware programmable network interface card, and if it is determined that the second ROCE message is allowed to be forwarded, perform VXLAN encapsulation on the second RoCE message through the hardware programmable network interface card, to obtain a second VXLAN message, and send the second VXLAN message through the VXLAN tunnel.

In an optional implementation of this embodiment of the present application, the processing unit is further configured to obtain, through the hardware programmable network interface card, a source network protocol address, a destination network protocol address, and a destination port of the second RoCE message; obtain an access control identifier corresponding to the second RoCE message based on the source network protocol address, the destination network protocol address, and the destination port of the second RoCE message; determine an access control policy group corresponding to the second RoCE message based on the access control identifier corresponding to the second RoCE message and access control identifiers of access control policy groups that are preconfigured in the hardware programmable network interface card; and determine, based on an access control policy in the access control policy group corresponding to the second RoCE message, whether the second RoCE message is allowed to be forwarded.

In an optional implementation of this embodiment of the present application, the processing unit is further configured to: in the case where it is determined that the second RoCE message is prohibited from being forwarded, process the second RoCE message based on second preset software.

In an optional implementation of this embodiment of the present application, the processing unit is further configured to determine, through the hardware programmable network interface card, whether the second RoCE message is a congestion notification packet (CNP) message; if the second RoCE message is the CNP message, set a value of a differentiated services code point (DSCP) in an outer network protocol header of the second RoCE message to a first preset value; or if the second RoCE message is not the CNP message, set a value of a DSCP in the outer network protocol header of the second RoCE message to a second preset value.

In an optional implementation of this embodiment of the present application, the processing unit is further configured to write the second VXLAN message into a message queue, and sequentially send VXLAN messages in the message queue at a rate less than or equal to a second bandwidth.

According to a third aspect, an embodiment of the present application provides a hardware device. The hardware device includes a memory, a processor, and a hardware programmable network interface card, where the memory is configured to store a computer program, and the processor is configured to, when executing the computer program, enable the hardware device to implement the remote direct memory access method according to any one of the above implementations.

According to a fourth aspect, an embodiment of the present application provides a computer-readable storage medium. When the computer program is executed by a computing device, the computing device is enabled to implement the remote direct memory access method according to any one of the above implementations.

According to a fifth aspect, an embodiment of the present application provides a computer program product. When the computer program product runs on a computer, the computer is enabled to implement the remote direct memory access method according to any one of the above implementations.

In the remote direct memory access method provided in this embodiment of the present application, when a first virtual extensible local area network (VXLAN) message sent by a first virtual machine through a VXLAN tunnel is received, VXLAN decapsulation is performed on the first VXLAN message through a hardware programmable network interface card based on a virtual switch, to obtain a first RoCE message, and access control is performed on the first RoCE message through the hardware programmable network interface card. The hardware programmable network interface card based on the virtual switch is preconfigured based on software of the virtual switch, so that software functions of the virtual switch are implemented through hardware of the network interface card. In the remote direct memory access method provided in this embodiment of the present application, the VXLAN decapsulation may be performed on the first VXLAN message through the hardware programmable network interface card, to obtain the first RoCE message, and the access control is performed on the first RoCE message through the hardware programmable network interface card.

### BRIEF DESCRIPTION OF THE DRAWINGS

The drawings, which are incorporated in and constitute a part of this specification, illustrate embodiments consistent with the present application and, together with the description, serve to explain the principles of the present application.

To illustrate the technical solutions in the embodiments of the present application or in the prior art more clearly, the following briefly introduces the drawings required for describing the embodiments or the prior art. Apparently, a person of ordinary skill in the art may still derive other drawings from these drawings without creative efforts.

FIG. 1 is a schematic diagram of a structure of a hardware device according to an embodiment of the present application;

FIG. 2 is a first flowchart of a remote direct memory access method according to an embodiment of the present application;

FIG. 3 is a schematic diagram of a structure of a RoCE message in a non-virtualization scenario according to an embodiment of the present application;

FIG. 4 is a schematic diagram of a structure of a RoCE message in a virtualization scenario according to an embodiment of the present application;

FIG. 5 is a schematic diagram of a procedure of processing, by a hardware programmable network interface card, a received RoCE message according to an embodiment of the present application;

FIG. 6 is a second flowchart of a remote direct memory access method according to an embodiment of the present application;

FIG. 7 is a schematic diagram of a procedure of processing, by a hardware programmable network interface card, a RoCE message that needs to be sent according to an embodiment of the present application;

FIG. 8 is a schematic diagram of a structure of a remote direct memory access apparatus according to an embodiment of the present application; and

FIG. 9 is a schematic diagram of a hardware structure of a hardware device according to an embodiment of the present application.

### DETAILED DESCRIPTION OF EMBODIMENTS

To enable a better understanding of the above objectives, features, and advantages of the present application, the solutions of the present application are described in detail below. It should be noted that the embodiments of the present application and features of the embodiments may be combined with each other without conflict.

Many specific details are set forth in the following description to provide a thorough understanding of the present application. However, the present application may be implemented in other manners different from those described herein. Apparently, the embodiments described in this specification are merely some rather than all of embodiments of the present application.

In the embodiments of the present application, the terms “exemplary” or “for example” are used to represent giving an example, an illustration, or a description. Any embodiment or design solution described as “exemplary” or “for example” in the embodiments of the present application should not be explained as being more preferable or advantageous than another embodiment or design solution. Indeed, the use of the terms “exemplary” or “for example” is intended to present related concepts in a specific manner. In addition, in the description of the embodiments of the present application, unless otherwise specified, the term “a plurality of” means two or more.

An RDMA application is very sensitive to a delay, and delay jitter caused by software forwarding of the virtual switch may result in failure to satisfy a delay requirement of a RoCE message based on software forwarding of the virtual switch. A hardware device for performing the remote direct memory access method provided in the embodiments of the present application is first described below.

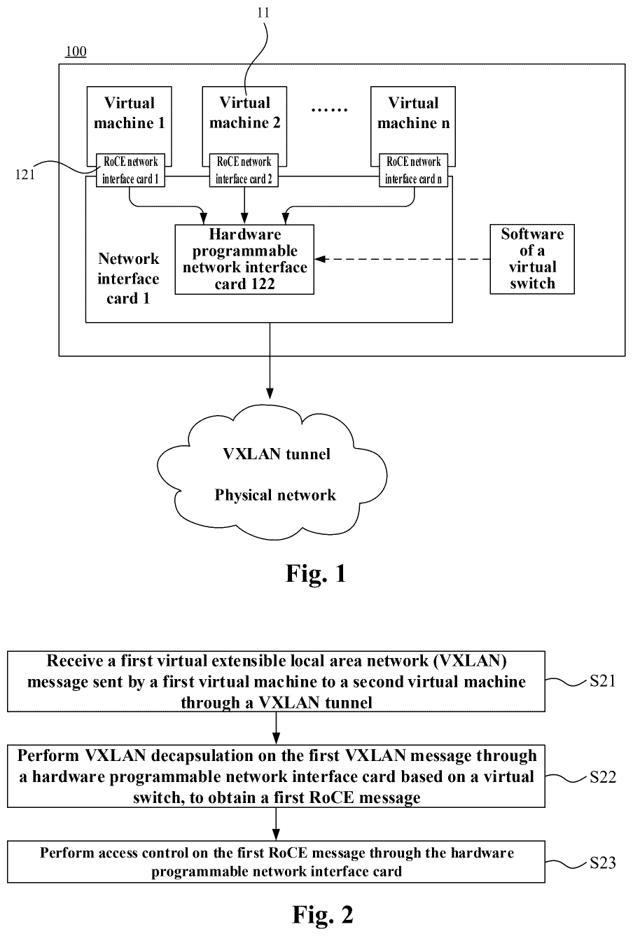

Referring to FIG. 1, the hardware device 100 for performing the remote direct memory access method provided in the embodiments of the present application includes at least one virtual machine (a virtual machine 1, a virtual machine 2, . . . , a virtual machine n) 11 created based on a virtualization function and a network interface card (NIC) 12. The network interface card 12 includes ROCE network interface cards (a RoCE network interface card 1, a RoCE network interface card 2, . . . , a RoCE network interface card n) 121 virtualized for the virtual machines and a hardware programmable network interface card 122 based on a virtual switch.

In some embodiments, the network interface card 12 may be virtualized, by using a single root I/O virtualization (SR-IOV) technology, into the RoCE network interface cards for the virtual machines.

The SR-IOV technology is a hardware-assisted virtualization technology, and allows a single network interface card to be virtualized into a plurality of independent virtual functions (VFs). Each virtual function may be independently allocated to a different virtual machine (VM) or container for use. The SR-IOV technology allows each virtual instance to directly access a hardware resource without intervention of a host. Therefore, the SR-IOV technology can significantly improve performance of a virtualization environment.

The SR-IOV allows a device (VERBS DEV) configured in each virtual machine in the virtualization environment and configured to perform an RDMA operation to have a globally unique identifier (GUID) bound to a VPC IP and an independent ROCE processing capability.

In some embodiments, the hardware programmable network interface card 122 based on the virtual switch means that the hardware programmable network interface card 122 is configured based on software of the virtual switch, so that the hardware programmable network interface card 122 can implement a same or similar function as the virtual switch. That is, the hardware programmable network interface card 122 based on the virtual switch is preconfigured based on the software of the virtual switch, so that the software functions of the virtual switch are implemented through hardware of the network interface card.

In the virtual private cloud environment, VPC traffic is implemented by using a VPC private IP, and RoCE devices are interconnected through a virtual extensible local area network (VXLAN) tunnel; and different virtual network identifiers (VNIs) implement isolation between different tenants. The VXLAN tunnel is transparent to a RoCE user, and the user does not perceive an implementation of a transport layer. Processing of the VPC traffic is usually performed by the virtual switch. The virtual switch mainly includes the following functions.
1. VPC security policy: Perform security group configuration, and determine whether a current host can perform ROCE communication with a remote host.
2. VPC mapping: Map an IP of a destination virtual machine in a VPC to an underlay IP address of a host on which the destination virtual machine is located.
3. VXLAN encapsulation/decapsulation: encapsulate a VPC message into a VXLAN message and send the VXLAN message, and perform decapsulation on the VXLAN message in a reverse direction, to obtain the VPC message.

Therefore, the hardware programmable network interface card 122 is configured based on the software of the virtual switch, so that the hardware programmable network interface card can implement the functions of executing the VPC security policy, performing the VPC mapping, and performing the VXLAN encapsulation/decapsulation.

Based on the above content, an embodiment of the present application further provides a remote direct memory access method. The remote direct memory access method is applied to the hardware device shown in FIG. 1. Referring to FIG. 2, the remote direct memory access method includes the following steps.

S21: Receive a first virtual extensible local area network (VXLAN) message sent by a first virtual machine to a second virtual machine through a VXLAN tunnel.

The first VXLAN message is generated by performing VXLAN encapsulation on a remote direct memory access (RDMA) over Converged Ethernet (RoCE) message.

That is, the first VXLAN message sent by the first virtual machine is received through the VXLAN tunnel between the second virtual machine and the first virtual machine.

S22: Perform VXLAN decapsulation on the first VXLAN message through a hardware programmable network interface card based on a virtual switch, to obtain a first RoCE message.

The hardware programmable network interface card based on the virtual switch is preconfigured based on software of the virtual switch, so that software functions of the virtual switch are implemented through hardware of the network interface card.

That is, after the first VXLAN message is received, VXLAN decapsulation is first performed on the VXLAN message through the hardware programmable network interface card based on the virtual switch, to obtain an original VPC message before VXLAN encapsulation is performed. The first VXLAN message is a VXLAN message obtained by performing VXLAN encapsulation on the RoCE message. Therefore, the first RoCE message may be obtained by performing the VXLAN decapsulation on the first VXLAN message through the hardware programmable network interface card.

S23: Perform access control on the first RoCE message through the hardware programmable network interface card.

In some embodiments, the performing access control on the first RoCE message through the hardware programmable network interface card includes the following steps a to d.

Step a: Obtain a source network protocol address, a destination network protocol address, and a destination port of the first RoCE message.

In this embodiment of the present application, the source network protocol address of the first ROCE message is an internet protocol address used by a device that sends the first RoCE message, that is, an IP address of the first virtual machine. The destination network protocol address of the first RoCE message is an internet protocol address of a device that receives the first RoCE message, that is, an IP address of the virtual machine that is created on the hardware device and that receives the first RoCE message. The destination port of the first RoCE message is an address of a port that is on the device that receives the first RoCE message and that is configured to receive the first RoCE message.

Step b: Obtain an access control identifier corresponding to the first RoCE message based on the source network protocol address, the destination network protocol address, and the destination port of the first RoCE message.

That is, the access control identifier key1 corresponding to the first RoCE message is: key1={the source network protocol address of the first RoCE message, the destination network protocol address of the first RoCE message, the destination port of the first RoCE message}.

It should be noted that because a source port (Source Port) is generally used as part of hash entropy of equal-cost multipath routing (ECMP) and a random value is obtained through a specific calculation method, in this embodiment of the present application, the access control identifier corresponding to the first RoCE message is not obtained based on a source port of the first RoCE message.

Step c: Determine an access control policy group corresponding to the first RoCE message based on the access control identifier corresponding to the first RoCE message and access control identifiers of access control policy groups that are preconfigured in the hardware programmable network interface card.

In some embodiments, the access control identifier corresponding to the first RoCE message and the access control identifiers of the access control policy groups that are preconfigured in the hardware programmable network interface card may be matched, and an access control policy group whose access control identifier matches the access control identifier corresponding to the first RoCE message is determined as the access control policy group corresponding to the first RoCE message.

Step d: Determine, based on an access control policy in the access control policy group corresponding to the first RoCE message, whether the first RoCE message is allowed to be forwarded.

Based on the above embodiment, the user may configure different access control policy groups for communication between different virtual machines based on a security requirement and a service requirement of the user.

In some embodiments, after the above step d (determining, based on the access control policy in the access control policy group corresponding to the first RoCE message, whether the first RoCE message is allowed to be forwarded) is performed, the remote direct memory access method provided in this embodiment of the present application further includes: in the case where it is determined that the first RoCE message is allowed to be forwarded, forwarding the first RoCE message to the ROCE network interface card of the second virtual machine through the hardware programmable network interface card.

The second virtual machine is the virtual machine whose IP address is the destination IP address of the first RoCE message.

In some embodiments, after the above step d (determining, based on the access control policy in the access control policy group corresponding to the first RoCE message, whether the first RoCE message is allowed to be forwarded) is performed, the remote direct memory access method provided in this embodiment of the present application further includes: in the case where it is determined that the first RoCE message is prohibited from being forwarded, processing the first RoCE message based on first preset software.

In some embodiments, the processing the first RoCE message based on the first preset software includes: generating a security log corresponding to the first RoCE message, and saving the security log corresponding to the first RoCE message to a specified storage location.

In the remote direct memory access method provided in this embodiment of the present application, when a first virtual extensible local area network (VXLAN) message sent by a first virtual machine through a VXLAN tunnel is received, VXLAN decapsulation is performed on the first VXLAN message through a hardware programmable network interface card based on a virtual switch, to obtain a first RoCE message, and access control is performed on the first RoCE message through the hardware programmable network interface card. The hardware programmable network interface card based on the virtual switch is preconfigured based on software of the virtual switch, so that software functions of the virtual switch are implemented through hardware of the network interface card. In the remote direct memory access method provided in this embodiment of the present application, the VXLAN decapsulation may be performed on the first VXLAN message through the hardware programmable network interface card, to obtain the first RoCE message, and the access control is performed on the first RoCE message through the hardware programmable network interface card. Compared with software forwarding based on a virtual switch in the related art, in the remote direct memory access method provided in this embodiment of the present application, the received RoCE message is processed through the hardware programmable network interface card. Therefore, in this embodiment of the present application, a delay of the RoCE message in the virtual private cloud environment can be reduced, and then RoCEv2 is deployed in the virtual private cloud environment.

In some embodiments, the remote direct memory access method provided in this embodiment of the present application further includes: determining, through the hardware programmable network interface card, whether an outer network protocol header of the first RoCE message includes an ECN mark; and if the outer network protocol header of the first RoCE message includes the ECN mark, adding the ECN mark to an inner network protocol header of the first RoCE message.

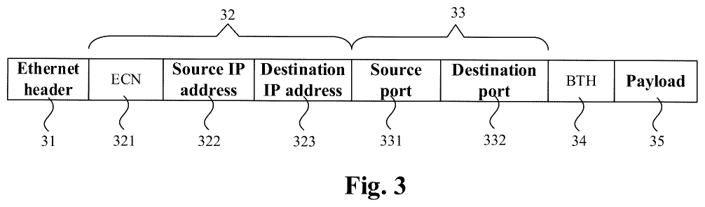

FIG. 3 is a schematic diagram of a structure of a RoCE message in a non-virtualization scenario. As shown in FIG. 3, the RoCE message in the non-virtualization scenario includes an Ethernet header 31, an IP header 32, a user datagram protocol (UDP) header 33, a transport layer header (InfiniBand Base Transport Header, BTH) 34, and a message payload 35. The Ethernet header 31 includes a source media access control (MAC) address and a destination MAC address. The IP header 32 includes an explicit congestion notification (ECN) flag 321, a source IP address 322, and a destination IP address 323. The UDP header 33 includes a source port 331 and a destination port 332. In some embodiments, the destination port of the RoCE message is a fixed value: 4791.

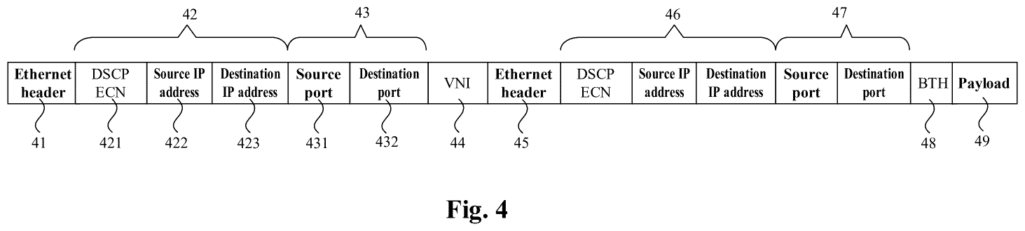

FIG. 4 is a schematic diagram of a structure of a RoCE message in a virtualization scenario. As shown in FIG. 4, the RoCE message in the virtualization scenario includes an outer Ethernet header 41, an outer IP header 42, an outer UDP header 43, a virtual network identifier (VXLAN Network Identifier, VNI) 44, an inner Ethernet header 45, an inner IP header 46, an inner UDP header 47, a BTH 48, and a message payload 49. The outer Ethernet header 42 includes a differentiated services code point (DSCP) and an ECN field 411, a source IP address 422, and a destination IP address 423. The source IP address 422 is a physical address of a host of the source virtual machine, and the destination IP address 423 is a physical address of a host of the destination virtual machine. The UDP header 43 includes a source port 431 and a destination port 432. The source port 431 is a physical port to which the source port belongs, and the destination port 432 is a physical port to which the port belongs. The inner Ethernet header 46 includes a DSCP and an ECN field 461, a source IP address 462, and a destination IP address 463. The inner UDP header 48 includes a source port 481 and a destination port 482.

When a physical switch in a physical network forwards and processes a RoCE message in a virtual private cloud environment, the physical switch forwards and processes the RoCE message based on the outer Ethernet header 41, the outer network protocol header 42, and the outer UDP header 43. Therefore, when traffic of the RoCE message exceeds a preset threshold, the physical switch sets a value of the ECN field in the outer network protocol header 42 to a preset value (for example, 1). The hardware programmable network interface card forwards and processes a message based on the VNI 44, the inner Ethernet header 45, the inner network protocol header 46, and the inner UDP header 47. The virtual machine determines whether congestion occurs and performs subsequent processing based on only a value of the ECN field in the inner network protocol header 46. Therefore, when the hardware programmable network interface card determines that the outer network protocol header of the first RoCE message includes the ECN mark, the ECN mark in the outer network protocol header needs to be added to the inner network protocol header of the first RoCE message, so that the virtual machine can normally implement a congestion detection function.

In some embodiments, the adding the ECN mark to the inner network protocol header of the first RoCE message includes:
setting a value of an ECN field in the inner network protocol header of the first RoCE message to a preset value.

In some embodiments, the preset value is 1.

In some embodiments, the remote direct memory access method provided in this embodiment of the present application further includes:
performing, through the hardware programmable network interface card, bandwidth measurement on traffic of a RoCE message sent by the first virtual machine, to obtain a first bandwidth, and determining whether the first bandwidth is greater than a bandwidth threshold; and if the first bandwidth is greater than the bandwidth threshold, adding an ECN mark to an inner network protocol header of the first RoCE message.

That is, if it is detected that the bandwidth occupied by the traffic of the RoCE message sent by the first virtual machine is greater than a preset bandwidth, the ECN mark is added to the inner network protocol header 46 in the message structure shown in FIG. 4.

Similarly, the adding the ECN mark to the inner network protocol header of the first RoCE message may be: setting a value of an ECN field in the inner network protocol header of the first RoCE message to a preset value.

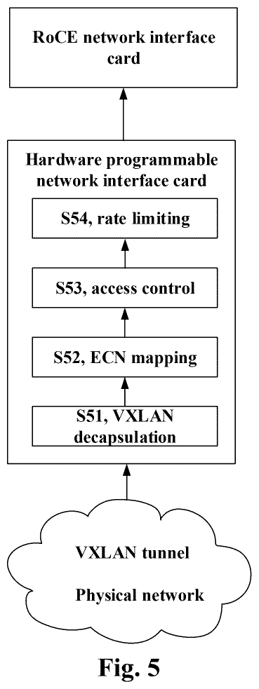

Referring to FIG. 5, the processing, by the hardware programmable network interface card, on the first VXLAN message includes the following steps.
S51: VXLAN decapsulation. That is, VXLAN decapsulation is performed on the first VXLAN message, to obtain the first RoCE message.
S52: ECN mapping. That is, if the outer network protocol header includes the ECN mark, the ECN mark is copied to the inner network protocol header.
S53: Access control. That is, the access control identifier corresponding to the first RoCE message is obtained based on the source network protocol address, the destination network protocol address, and the destination port of the first RoCE message, the access control policy group corresponding to the first ROCE message is determined based on the access control identifier corresponding to the first RoCE message, and whether the first RoCE message is allowed to be forwarded is determined based on the access control policy in the access control policy group corresponding to the first RoCE message.
S54: Rate limiting. That is, the bandwidth occupied by the traffic of the RoCE message sent by the first virtual machine is obtained, and if the first bandwidth is greater than the bandwidth threshold, the ECN mark is added to the inner network protocol header of the first RoCE message.

It should be noted that in this embodiment of the present application, the execution sequence of the above steps S51 to S54 is not limited, and the hardware programmable network interface card may perform the above steps S51 to S54 on the first RoCE message in any sequence. For example, step S53 may be first performed to perform access control on the first RoCE message, and then step S54 is performed to perform rate limiting on the first RoCE message. Alternatively, step S55 may be first performed to perform rate limiting on the first ROCE message, and then step S53 is performed to perform access control on the first RoCE message.

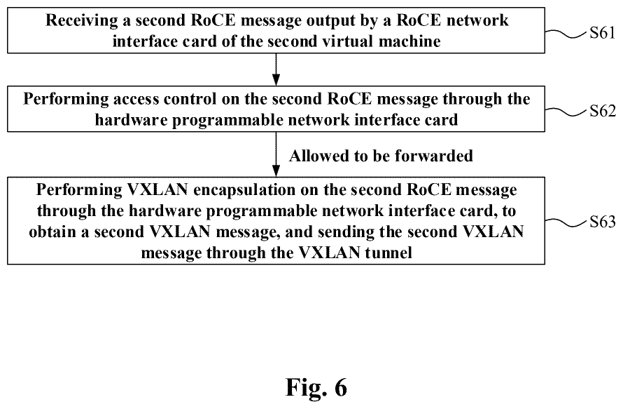

Referring to FIG. 6, the remote direct memory access method provided in this embodiment of the present application further includes the following steps.
S61: Receive a second RoCE message output by a RoCE network interface card of the second virtual machine.
S62: Perform access control on the second RoCE message through the hardware programmable network interface card.

In some embodiments, the performing access control on the second RoCE message through the hardware programmable network interface card includes the following steps 1 to 4.

Step 1: Obtain a source network protocol address, a destination network protocol address, and a destination port of the second RoCE message.

A difference from the above step a lies in that the source network protocol address and the destination network protocol address of the first RoCE message that are obtained in step a are the internet protocol address of the first virtual machine and the internet protocol address of the second virtual machine, while the source network protocol address and the destination network protocol address of the second RoCE message that are obtained in the above step 1 are the internet protocol address of the second virtual machine and the internet protocol address of the first virtual machine.

Step 2: Obtain an access control identifier corresponding to the second RoCE message based on the source network protocol address, the destination network protocol address, and the destination port of the second RoCE message.

That is, the access control identifier key2 corresponding to the second RoCE message is: key2={the source network protocol address of the second RoCE message, the destination network protocol address of the second RoCE message, the destination port of the second RoCE message}.

Step 3: Determine an access control policy group corresponding to the second RoCE message based on the access control identifier corresponding to the second RoCE message and access control identifiers of access control policy groups that are preconfigured in the hardware programmable network interface card.

Step 4: Determine, based on an access control policy in the access control policy group corresponding to the second RoCE message, whether the second RoCE message is allowed to be forwarded.

In the above step S62, if it is determined that the second RoCE message is allowed to be forwarded, the following step S63 is performed.
S63: Perform VXLAN encapsulation on the second RoCE message through the hardware programmable network interface card, to obtain a second VXLAN message, and send the second VXLAN message through the VXLAN tunnel.

In some embodiments, the sending the second VXLAN message through the VXLAN tunnel includes:
writing the second VXLAN message into a message queue, and sequentially sending VXLAN messages in the message queue at a rate less than or equal to a second bandwidth.

In a multi-tenant environment, RDMA bandwidths of a plurality of tenants need to be isolated. Therefore, in the above embodiment, the VXLAN messages in the message queue are sequentially sent at the rate less than or equal to the second bandwidth. The second bandwidth is a maximum bandwidth that can be used by a current tenant.

In addition, the second VXLAN message is first written into the message queue, and then the VXLAN messages in the message queue are sequentially sent, so that it can be ensured that the RoCE message is prevented from a packet loss due to rate limiting.

In some embodiments, if it is determined, in the above step S62, that the second RoCE message is prohibited from being forwarded when the access control is performed on the second RoCE message through the hardware programmable network interface card, the second RoCE message is processed based on second preset software.

Exemplarily, the processing the second RoCE message based on the second preset software includes: generating a security log corresponding to the second RoCE message, and writing the security log corresponding to the second RoCE message into a specified storage location.

In some embodiments, the remote direct memory access method provided in this embodiment of the present application further includes:
determining, through the hardware programmable network interface card, whether the second ROCE message is a congestion notification packet (CNP) message; if the second RoCE message is the CNP message, setting a value of a DSCP in an outer network protocol header of the second RoCE message to a first preset value; or if the second RoCE message is not the CNP message, setting a value of a DSCP in the outer network protocol header of the second RoCE message to a second preset value.

Specifically, the CNP message is a control packet in RoCEv2, and is used to notify a sender that a network is congested. When receiving a data package with an ECN mark, a receiver sends a CNP to the sender, to instruct the sender to actively reduce a sending rate based on a congestion algorithm, so as to relieve a current congestion. Application of an ECN/CNP control loop avoids a loss of the RoCE message and a sharp drop of a bandwidth caused by the packet loss.

The hardware programmable network interface card sets the value of the DSCP in the outer network protocol header of the second RoCE message to the first preset value if the second RoCE message is the CNP message, or sets the value of the DSCP in the outer network protocol header of the second RoCE message to the second preset value if the second RoCE message is not the CNP message. Therefore, in the above embodiment, the ordinary RoCE message and the CNP message may be distinguished based on the value of the DSCP in the outer network protocol header, so that the CNP message is preferentially processed.

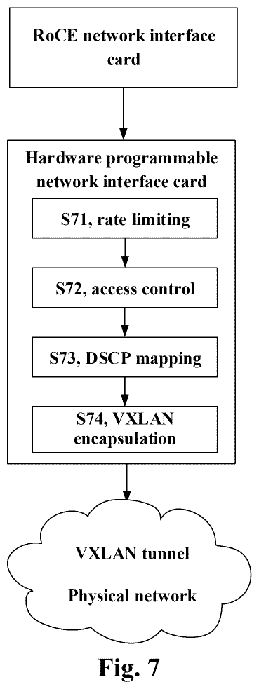

Referring to FIG. 7, the processing, by the hardware programmable network interface card, on the second RoCE message includes the following steps.
S71: Rate limiting. That is, the second VXLAN message is written into the message queue, and the VXLAN messages in the message queue are sequentially sent at the rate less than or equal to the second bandwidth.
S72: Access control. That is, the access control identifier corresponding to the second RoCE message is obtained based on the source network protocol address, the destination network protocol address, and the destination port of the second RoCE message, the access control policy group corresponding to the second ROCE message is determined based on the access control identifier corresponding to the second RoCE message, and whether the second RoCE message is allowed to be forwarded is determined based on the access control policy in the access control policy group corresponding to the second RoCE message.
S73: DSCP mapping. That is, if the second RoCE message is the ordinary RoCE message, the value of the DSCP in the outer network protocol header is set to the first preset value, or if the second RoCE message is the CNP message, the value of the DSCP in the outer network protocol header is set to the second preset value.
S74: VXLAN encapsulation. That is, VXLAN encapsulation is performed on the second ROCE message, to obtain the second VXLAN message.

Similarly, in this embodiment of the present application, the execution sequence of the above steps S71 to S74 is not limited, and the hardware programmable network interface card may perform the above steps S71 to S74 on the second RoCE message in any sequence.

Based on the same inventive concept, as an implementation of the foregoing method, an embodiment of the present application further provides a remote direct memory access apparatus. This embodiment corresponds to the foregoing method embodiments. For ease of reading, details of the foregoing method embodiments are not described in this embodiment one by one. However, it should be clear that the remote direct memory access apparatus in this embodiment can implement all content in the foregoing method embodiments.

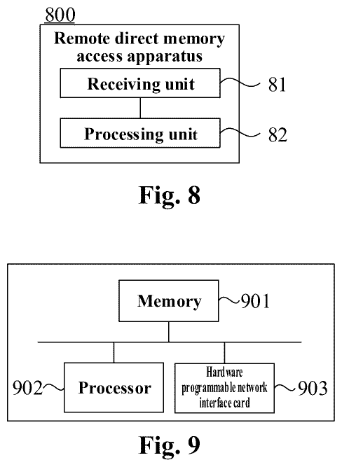

An embodiment of the present application provides a remote direct memory access apparatus. FIG. 8 is a schematic diagram of a structure of the remote direct memory access apparatus. As shown in FIG. 8, the remote direct memory access apparatus 800 includes:
a receiving unit 81, configured to receive a first virtual extensible local area network (VXLAN) message sent by a first virtual machine to a second virtual machine through a VXLAN tunnel, where the first VXLAN message is generated by performing VXLAN encapsulation on a remote direct memory access (RDMA) over Converged Ethernet (RoCE) message; and
a processing unit 82, configured to perform VXLAN decapsulation on the first VXLAN message through a hardware programmable network interface card based on a virtual switch, to obtain a first RoCE message, and perform access control on the first RoCE message through the hardware programmable network interface card, where the hardware programmable network interface card based on the virtual switch is preconfigured based on software of the virtual switch, so that software functions of the virtual switch are implemented through hardware of the network interface card.

In an optional implementation of this embodiment of the present application, the processing unit 82 is further configured to obtain, through the hardware programmable network interface card, a source network protocol address, a destination network protocol address, and a destination port of the first RoCE message; obtain an access control identifier corresponding to the first RoCE message based on the source network protocol address, the destination network protocol address, and the destination port of the first RoCE message; determine an access control policy group corresponding to the first RoCE message based on the access control identifier corresponding to the first RoCE message and access control identifiers of access control policy groups that are preconfigured in the hardware programmable network interface card; and determine, based on an access control policy in the access control policy group corresponding to the first RoCE message, whether the first ROCE message is allowed to be forwarded.

In an optional implementation of this embodiment of the present application, the processing unit 82 is further configured to: in the case where it is determined that the first RoCE message is allowed to be forwarded, forward the first RoCE message to the ROCE network interface card of the second virtual machine through the hardware programmable network interface card; or in the case where it is determined that the first RoCE message is prohibited from being forwarded, process the first RoCE message based on the first preset software.

In an optional implementation of this embodiment of the present application, the processing unit 82 is further configured to determine, through the hardware programmable network interface card, whether the outer network protocol header of the first RoCE message includes the explicit congestion notification (ECN) mark; and if the outer network protocol header of the first RoCE message includes the ECN mark, add the ECN mark to the inner network protocol header of the first RoCE message.

In an optional implementation of this embodiment of the present application, the processing unit 82 is further configured to perform, through the hardware programmable network interface card, bandwidth measurement on traffic of a RoCE message sent by the first virtual machine, to obtain a first bandwidth, and determine whether the first bandwidth is greater than a bandwidth threshold; and if the first bandwidth is greater than the bandwidth threshold, add an ECN mark to an inner network protocol header of the first RoCE message.

In an optional implementation of this embodiment of the present application, the receiving unit 81 is further configured to receive a second RoCE message output by a RoCE network interface card of the second virtual machine.

The processing unit 82 is further configured to perform access control on the second RoCE message through the hardware programmable network interface card, and if it is determined that the second ROCE message is allowed to be forwarded, perform VXLAN encapsulation on the second RoCE message through the hardware programmable network interface card, to obtain a second VXLAN message, and send the second VXLAN message through the VXLAN tunnel.

In an optional implementation of this embodiment of the present application, the processing unit 82 is further configured to obtain, through the hardware programmable network interface card, a source network protocol address, a destination network protocol address, and a destination port of the second RoCE message; obtain an access control identifier corresponding to the second RoCE message based on the source network protocol address, the destination network protocol address, and the destination port of the second RoCE message; determine an access control policy group corresponding to the second RoCE message based on the access control identifier corresponding to the second RoCE message and access control identifiers of access control policy groups that are preconfigured in the hardware programmable network interface card; and determine, based on an access control policy in the access control policy group corresponding to the second RoCE message, whether the second RoCE message is allowed to be forwarded.

In an optional implementation of this embodiment of the present application, the processing unit 82 is further configured to: in the case where it is determined that the second RoCE message is prohibited from being forwarded, process the second RoCE message based on second preset software.

In an optional implementation of this embodiment of the present application, the processing unit 82 is further configured to determine, through the hardware programmable network interface card, whether the second RoCE message is a congestion notification packet (CNP) message; if the second RoCE message is the CNP message, set a value of a differentiated services code point (DSCP) in an outer network protocol header of the second RoCE message to a first preset value; or if the second RoCE message is not the CNP message, set a value of a DSCP in the outer network protocol header of the second RoCE message to a second preset value.

In an optional implementation of this embodiment of the present application, the processing unit 82 is further configured to write the second VXLAN message into a message queue, and sequentially send VXLAN messages in the message queue at a rate less than or equal to a second bandwidth.

The hardware device provided in this embodiment of the present application can perform the remote direct memory access method provided in any one of the above embodiments. The implementation principle and technical effect thereof are similar, and details are not described herein again.

Based on the same inventive concept, an embodiment of the present application further provides a hardware device. FIG. 9 is a schematic diagram of a structure of the hardware device provided in this embodiment of the present application. As shown in FIG. 9, the hardware device provided in this embodiment includes a memory 901, a processor 902, and a hardware programmable network interface card 903. The memory 901 is configured to store a computer program, and the processor 902 and the hardware programmable network interface card 903 are configured to, when executing the computer program, perform the remote direct memory access method provided in the above embodiments.

Based on the same inventive concept, an embodiment of the present application further provides a computer-readable storage medium. The computer-readable storage medium stores a computer program. When the computer program is executed by a processor, a computing device is enabled to implement the remote direct memory access method provided in the above embodiments.

Based on the same inventive concept, an embodiment of the present application further provides a computer program product. When the computer program product runs on a computer, the computer is enabled to implement the remote direct memory access method provided in the above embodiments.

It should be understood by persons skilled in the art that the embodiments of the present application may be provided as a method, a system, or a computer program product. Therefore, the present application may be implemented in a form of an entirely hardware embodiment, an entirely software embodiment, or a combination of software and hardware embodiments. Moreover, the present application may be implemented in a form of a computer program product implemented on one or more computer-usable storage media that include computer-usable program codes.

The processor may be a central processing unit (CPU), or may be another general-purpose processor, a digital signal processor (DSP), an application-specific integrated circuit (ASIC), a field-programmable gate array (FPGA), another programmable logic device, a discrete gate or transistor logic device, a discrete hardware component, or the like. The general-purpose processor may be a microprocessor, or the processor may be any conventional processor or the like.

The memory may include a non-permanent memory, a random access memory (RAM), and/or a non-volatile memory in a computer-readable medium, such as a read-only memory (ROM) or a flash memory (flash RAM). The memory is an example of the computer-readable medium.

The computer-readable medium includes permanent and non-permanent, removable and non-removable storage media. The storage medium may implement information storage by using any method or technology, and the information may be a computer-readable instruction, a data structure, a program module, or other data. Examples of the storage medium of the computer include but are not limited to a phase-change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical memory, a magnetic cassette, a magnetic disk storage or another magnetic storage device, or any other non-transmission medium that can be used to store information accessible by a computing device. According to the definitions herein, the computer-readable medium does not include a transitory media, such as a modulated data signal and a carrier.

Finally, it should be noted that the above embodiments are merely intended for describing the technical solutions of the present application but not intended to limit the present application. Although the present application has been described in detail with reference to the foregoing embodiments, persons of ordinary skill in the art should understand that the technical solutions described in the foregoing embodiments may still be modified, or some or all technical features thereof may be equivalently replaced. However, the modifications or replacements do not make the essence of the corresponding technical solutions depart from the scope of the technical solutions of the embodiments of the present application.

I/We claim:

1. A remote direct memory access method, comprising:
receiving a first virtual extensible local area network (VXLAN) message sent by a first virtual machine to a second virtual machine through a VXLAN tunnel, the first VXLAN message being generated by performing VXLAN encapsulation on a remote direct memory access (RDMA) over Converged Ethernet (ROCE) message; and
performing VXLAN decapsulation on the first VXLAN message through a hardware programmable network interface card based on a virtual switch, to obtain a first RoCE message, and performing access control on the first RoCE message through the hardware programmable network interface card, wherein the hardware programmable network interface card based on the virtual switch is preconfigured based on software of the virtual switch, to implement software functions of the virtual switch through hardware of the network interface card.

2. The method according to claim 1, wherein the performing access control on the first RoCE message through the hardware programmable network interface card comprises:
obtaining a source network protocol address, a destination network protocol address, and a destination port of the first RoCE message;
obtaining an access control identifier corresponding to the first RoCE message based on the source network protocol address, the destination network protocol address, and the destination port of the first ROCE message;
determining an access control policy group corresponding to the first RoCE message based on the access control identifier corresponding to the first RoCE message and an access control identifier of each access control policy group that is preconfigured in the hardware programmable network interface card; and
determining, based on an access control policy in the access control policy group corresponding to the first RoCE message, whether the first RoCE message is allowed to be forwarded.

3. The method according to claim 2, wherein the method further comprises:
in response to determining that the first RoCE message is allowed to be forwarded, forwarding the first RoCE message to a RoCE network interface card of the second virtual machine through the hardware programmable network interface card; and
in response to determining that the first RoCE message is prohibited from being forwarded, processing the first RoCE message based on first preset software.

4. The method according to claim 1, wherein the method further comprises:
determining, through the hardware programmable network interface card, whether an outer network protocol header of the first RoCE message comprises an explicit congestion notification (ECN) mark; and in response to the outer network protocol header of the first RoCE message comprising the ECN mark, adding the ECN mark to an inner network protocol header of the first RoCE message.

5. The method according to claim 1, wherein the method further comprises:
performing, through the hardware programmable network interface card, bandwidth measurement on traffic of a RoCE message sent by the first virtual machine, to obtain a first bandwidth; determining whether the first bandwidth is greater than a bandwidth threshold; and in response to the first bandwidth being greater than the bandwidth threshold, adding an ECN mark to an inner network protocol header of the first RoCE message.

6. The method according to claim 1, wherein the method further comprises:
receiving a second RoCE message output by a RoCE network interface card of the second virtual machine; and
performing access control on the second RoCE message through the hardware programmable network interface card, and in response to determining that the second RoCE message is allowed to be forwarded, performing VXLAN encapsulation on the second RoCE message through the hardware programmable network interface card, to obtain a second VXLAN message, and sending the second VXLAN message through the VXLAN tunnel.

7. The method according to claim 6, wherein the performing access control on the second RoCE message through the hardware programmable network interface card comprises:
obtaining a source network protocol address, a destination network protocol address, and a destination port of the second RoCE message;
obtaining an access control identifier corresponding to the second RoCE message based on the source network protocol address, the destination network protocol address, and the destination port of the second ROCE message;
determining an access control policy group corresponding to the second RoCE message based on the access control identifier corresponding to the second RoCE message and an access control identifier of each access control policy group that is preconfigured in the hardware programmable network interface card; and
determining, based on an access control policy in the access control policy group corresponding to the second RoCE message, whether the second RoCE message is allowed to be forwarded.

8. The method according to claim 7, wherein the method further comprises:
in response to determining that the second RoCE message is prohibited from being forwarded, processing the second RoCE message based on second preset software.

9. The method according to claim 6, wherein the method further comprises:
determining, through the hardware programmable network interface card, whether the second RoCE message is a congestion notification packet (CNP) message; in response to the second RoCE message being the CNP message, setting a value of a differentiated services code point (DSCP) in an outer network protocol header of the second RoCE message to a first preset value; and in response to the second RoCE message being not the CNP message, setting a value of a DSCP in the outer network protocol header of the second RoCE message to a second preset value.

10. The method according to claim 6, wherein the sending the second VXLAN message through the VXLAN tunnel comprises:
writing the second VXLAN message into a message queue, and sequentially sending VXLAN messages in the message queue at a rate within a second bandwidth.

11. A hardware device, comprising: a memory, a processor, and a hardware programmable network interface card, wherein the memory is configured to store instructions, and the processor and the hardware programmable network interface card are configured to, when executing the instructions, cause the hardware device to:
receive a first virtual extensible local area network (VXLAN) message sent by a first virtual machine to a second virtual machine through a VXLAN tunnel, the first VXLAN message being generated by performing VXLAN encapsulation on a remote direct memory access (RDMA) over Converged Ethernet (RoCE) message; and
perform VXLAN decapsulation on the first VXLAN message through a hardware programmable network interface card based on a virtual switch, to obtain a first RoCE message, and performing access control on the first RoCE message through the hardware programmable network interface card, wherein the hardware programmable network interface card based on the virtual switch is preconfigured based on software of the virtual switch, to implement software functions of the virtual switch through hardware of the network interface card.

12. The device according to claim 11, wherein the instructions causing the processor to perform access control on the first RoCE message through the hardware programmable network interface card comprise instructions causing the processor to:
obtain a source network protocol address, a destination network protocol address, and a destination port of the first RoCE message;
obtain an access control identifier corresponding to the first RoCE message based on the source network protocol address, the destination network protocol address, and the destination port of the first RoCE message;
determine an access control policy group corresponding to the first RoCE message based on the access control identifier corresponding to the first RoCE message and an access control identifier of each access control policy group that is preconfigured in the hardware programmable network interface card; and
determine, based on an access control policy in the access control policy group corresponding to the first RoCE message, whether the first RoCE message is allowed to be forwarded.

13. The device according to claim 12, wherein the device is further caused to:
in response to determining that the first RoCE message is allowed to be forwarded, forward the first RoCE message to a RoCE network interface card of the second virtual machine through the hardware programmable network interface card; and
in response to determining that the first RoCE message is prohibited from being forwarded, process the first RoCE message based on first preset software.

14. The device according to claim 11, wherein the device is further caused to:
determine, through the hardware programmable network interface card, whether an outer network protocol header of the first RoCE message comprises an explicit congestion notification (ECN) mark; and in response to the outer network protocol header of the first RoCE message comprising the ECN mark, add the ECN mark to an inner network protocol header of the first RoCE message.

15. The device according to claim 11, wherein the device is further caused to:
perform, through the hardware programmable network interface card, bandwidth measurement on traffic of a RoCE message sent by the first virtual machine, to obtain a first bandwidth; determine whether the first bandwidth is greater than a bandwidth threshold; and in response to the first bandwidth being greater than the bandwidth threshold, add an ECN mark to an inner network protocol header of the first RoCE message.

16. The device according to claim 11, wherein the device is further caused to:
receive a second RoCE message output by a RoCE network interface card of the second virtual machine; and
perform access control on the second RoCE message through the hardware programmable network interface card, and in response to determining that the second RoCE message is allowed to be forwarded, perform VXLAN encapsulation on the second RoCE message through the hardware programmable network interface card, to obtain a second VXLAN message, and send the second VXLAN message through the VXLAN tunnel.

17. The device according to claim 16, wherein the instructions causing the processor to perform access control on the second RoCE message through the hardware programmable network interface card comprise instructions causing the processor to:
obtain a source network protocol address, a destination network protocol address, and a destination port of the second RoCE message;
obtain an access control identifier corresponding to the second RoCE message based on the source network protocol address, the destination network protocol address, and the destination port of the second ROCE message;
determine an access control policy group corresponding to the second RoCE message based on the access control identifier corresponding to the second RoCE message and an access control identifier of each access control policy group that is preconfigured in the hardware programmable network interface card; and
determine, based on an access control policy in the access control policy group corresponding to the second RoCE message, whether the second RoCE message is allowed to be forwarded.

18. The device according to claim 17, wherein the device is further caused to:
in response to determining that the second RoCE message is prohibited from being forwarded, process the second RoCE message based on second preset software.

19. The method according to claim 16, wherein the device is further caused to:
determine, through the hardware programmable network interface card, whether the second ROCE message is a congestion notification packet (CNP) message; in response to the second RoCE message being the CNP message, set a value of a differentiated services code point (DSCP) in an outer network protocol header of the second RoCE message to a first preset value; and in response to the second RoCE message being not the CNP message, set a value of a DSCP in the outer network protocol header of the second RoCE message to a second preset value.

20. A non-transitory computer-readable storage medium, wherein the computer-readable storage medium stores a computer program, and the computer program, when executed by a computing device, causes the computing device to:
receive a first virtual extensible local area network (VXLAN) message sent by a first virtual machine to a second virtual machine through a VXLAN tunnel, the first VXLAN message being generated by performing VXLAN encapsulation on a remote direct memory access (RDMA) over Converged Ethernet (RoCE) message; and
perform VXLAN decapsulation on the first VXLAN message through a hardware programmable network interface card based on a virtual switch, to obtain a first RoCE message, and performing access control on the first RoCE message through the hardware programmable network interface card, wherein the hardware programmable network interface card based on the virtual switch is preconfigured based on software of the virtual switch, to implement software functions of the virtual switch through hardware of the network interface card.
